(19) United States
(12) Patent Application Publication
(10) Pub. No.: US 2023/0065613 A1
(43) Pub. Date: Mar. 2, 2023

(54) NUMERICAL CONTROL DEVICE

(71) Applicant: FANUC CORPORATION, Yamanashi (JP)

(72) Inventor: Nobuhito OONISHI, Yamanashi (JP)

(73) Assignee: FANUC CORPORATION, Yamanashi (JP)

(21) Appl. No.: 17/759,984

(22) PCT Filed: Feb. 15, 2021
(86) PCT No.: PCT/JP2021/005488

§ 371 Date: Aug. 2, 2022

(30) Foreign Application Priority Data
Feb. 20, 2020 (JP) 2020-027523

(51) Int. Cl. G05B 19/409

(52) U.S. Cl. CPC G05B 19/409

(57) ABSTRACT

Provided is a numerical control device which makes it possible to improve operating efficiency. The numerical control device according to the present invention controls a machine tool with a manually-operated handle, and is provided with a status identification unit that identifies a state of the numerical control device or the machine tool, and a haptic control unit that causes haptic feedback to be generated in the manually-operated handle on the basis of the status of the numerical control device or the machine tool identified by the status identification unit.

### TECHNICAL FIELD

The present invention relates to a numerical control device.

### BACKGROUND ART

Conventionally, technology for generating sound and vibrations according to load has been known in machine tools which perform axis feed by a manual handle (for example, refer to Patent Document 1). Patent Document 1 discloses a machine tool which includes a control means that varies the type of sound and vibration of a communicating means according to the magnitude of a detected load by a load detecting means.
Patent Document 1: Japanese Unexamined Patent Application, Publication No. H06-190691

### DISCLOSURE OF THE INVENTION

### Problems to be Solved by the Invention

However, such a machine tool and a numerical control device controlling the machine tool cannot allow an operator to intuitively feel the state of the machine tool or numerical control device, and thus the work efficiency has been impaired. For this reason, a numerical control device has been desired which can allow the operator to intuitively feel the state of the machine tool or numerical control device, and thus can improve the work efficiency.

### Means for Solving the Problems

A numerical control device according to the present disclosure controls a machine tool having a manual handle, the numerical control device including: a state identification section which identifies a state of the numerical control device or the machine tool; and a haptic control section which causes haptic feedback to be generated in the manual handle based on the state of the numerical control device or the machine tool identified by the state identification section.

### Effects of the Invention

According to the present invention, it is possible to improve work efficiency.

### BRIEF DESCRIPTION OF THE DRAWINGS

FIG. 1 is a view showing the configurations of a numerical control device and a machine tool according to the present embodiment;

FIG. 2 is a view showing an example of a state of the numerical control device;

FIG. 3 is a view showing an example of a state of the numerical control device;

FIG. 4 is a view showing an example of a state of the numerical control device;

FIG. 5 is a view showing an example of a state of the machine tool; and

FIG. 6 is a flowchart showing the flow of processing of the numerical control device.

### PREFERRED MODE FOR CARRYING OUT THE INVENTION

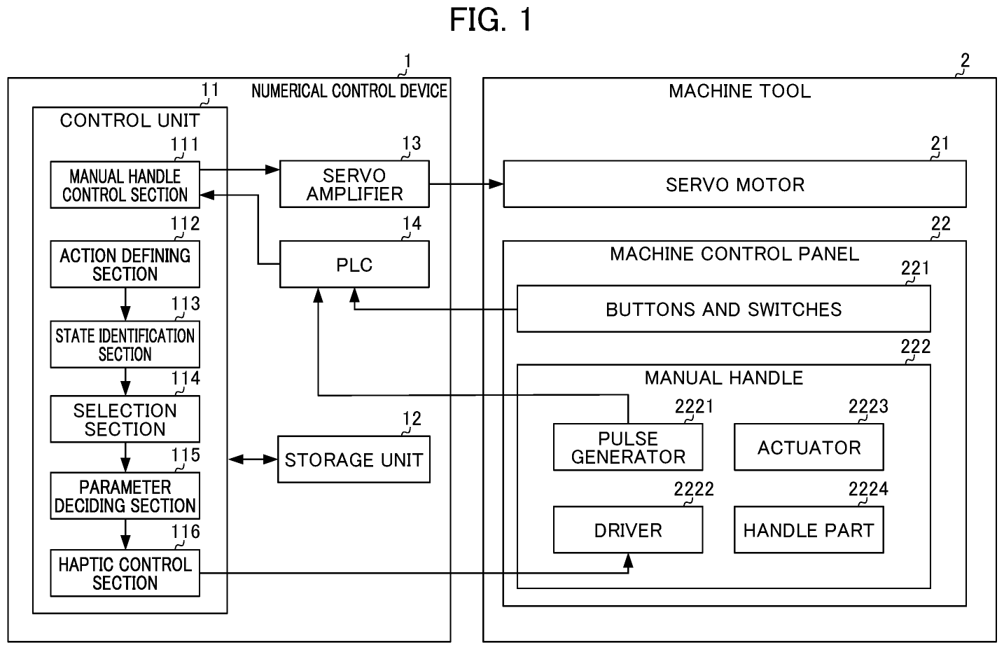

Hereinafter, an example of an embodiment of the present invention will be explained. FIG. 1 is a view showing configurations of a numerical control device 1 and a machine tool 2. The numerical control device 1 and machine tool 2 are connected by a bus (not shown) or the like, and the machine tool 2 operates in accordance with control of the numerical control device 1.

As shown in FIG. 1, the numerical control device 1 includes a control unit 11, a storage unit 12, a servo amplifier 13, and a PLC (Programmable Logic Controller) 14.

The control unit 11 is a processor such as a CPU (Central Processing Unit), and functions as a manual handle control section 111, action defining section 112, state identification section 113, selection section 114, parameter deciding section 115, and haptic control section 116, by executing programs stored in the storage unit 12.

The storage unit 12 is configured by ROM (read only memory), RAM (random access memory), non-volatile memory, hard disk drive, etc., and stores various data. For example, the storage unit 12 stores action definition data, parameters, etc. described later.

The servo amplifier 13 amplifies movement commands of axes received from the control unit 11, and drives the servo motor 21 of the machine tool 2. The PLC 14 receives M (auxiliary) function signals, S (spindle speed control) function signals, T (tool selection) function signals, etc. from the control unit 11. Then, the PLC 14 processes these signals by sequence programs, and outputs the processed output signals to the machine tool 2. The PLC 14 controls pneumatic equipment, hydraulic equipment, electromagnetic actuators, etc. in the machine tool 2 according to the output signals.

In addition, the PLC 14 receives various signals such as button signals, switch signals, and manual handle signals of the machine control panel 22 of the machine tool 2, and sequences the various signals received. Then, the PLC 14 sends the various signals thus sequenced to the control unit 11 via the bus.

The machine tool 2 includes the servo motor 21 and machine control panel 22. It should be noted that, in the present disclosure, other configurations of the machine tool 2 are omitted for simplification of explanation, and the machine tool 2 has the configuration of a general machine tool.

The servo motor 21 drives an axis according to the movement command of the axis received from the servo amplifier 13. The machine control panel 22 includes buttons and switches 221, and the manual handle 222. The buttons and switches 221 include mechanical buttons and switches. The buttons and switches 221 output button signals and switch signals to the PLC 14, when the mechanical buttons or switches are pressed.

The manual handle 222 moves one or a plurality of axes according to manual operation. The manual handle 222 includes a pulse generator 2221, driver 2222, actuator 2223 and handle part 2224.

The pulse generator 2221, when causing the handle unit 2224 to rotate in the + direction or − direction, outputs a pulse signal according to this rotation. This pulse signal is a two-phase pulse for determining the rotation direction, and is sent to the control unit 11 via the bus. Then, the manual handle control section 111 of the control unit 11 sends the movement command of an axis of the machine tool 2 to the servo amplifier 13 based on this pulse signal.

The driver 2222 receives control signals from the haptic control section 117 of the control unit 11, and outputs a drive signal for generating haptic feedback to the actuator 2223.

The actuator 2223 is driven by the drive signal from the driver 2222, and generates a haptic feedback. The actuator 2223, for example, may be an electric motor, an electromagnetic actuator, a shape-memory alloy, an electroactive polymer, a solenoid, an eccentric motor, a linear resonance actuator, a piezoelectric actuator or the like. In addition, the actuator 2223 may be configured by a plurality of different actuators.

The handle part 2224 is configured by a mechanical manual handle, for example, and is operated by an operator.

The manual handle control section 111 receives a pulse signal outputted from the pulse generator 2221. Then, the manual handle control section 111 sends a movement command of an axis of the machine tool 2 based on the pulse signal to the servo amplifier 13.

The action defining section 112 sets the action definition data defining the haptic feedback to be generated in the manual handle 222. The action definition data associates the state of the numerical control device 1 or machine tool 2 with the type of haptic feedback. The action definition data is stored in the storage unit 12.

The state identification section 113 identifies the state of the numerical control device 1 or machine tool 2. More specifically, the state identification section 113 identifies the state of the numerical control device 1 based on the operating state of the numerical control device 1. In addition, the state identification section 113 may identify the state of the numerical control device 1 based on an external signal inputted to the numerical control device 1. In addition, the state identification section 113 may identify the state of the machine tool 2 based on the state of the numerical control device 1 and machine information registered in the numerical control device. In addition, the state identification section 113 may identify the state of the machine tool 2 based on the state of the numerical control device 1 and a relational expression derived from machining theory or the like.

The selection section 114 selects the type of haptic feedback based on the action definition data and state of the numerical control device 1 or machine tool 2. A specific example of the state of the numerical control device 1 or machine tool 2 is described later.

The parameter deciding section 115 decides parameters related to haptic feedback, based on the type of haptic feedback selected by the selection section 114. Herein, the type of haptic feedback is associated with parameters related to the haptic feedback. The type of haptic feedback and the parameters related to haptic feedback are decided based on information stored in the storage unit 12 and the program execution state.

The parameters related to haptic feedback include the magnitude, direction, frequency, duration, amplitude, intensity, density, etc. of the haptic feedback.

The haptic control section 116 causes the haptic feedback to be generated in the manual handle 222, based on the state of the numerical control device 1 or machine tool 2 identified by the state identification section 113. More specifically, the haptic control section generates a control signal using the parameters decided by the parameter deciding section 115 based on the state of the numerical control device 1 or machine tool 2 identified by the state identification section 113, and notifies the control signal to the driver 2222. The haptic control section 116 thereby causes haptic feedback to be generated in the manual handle 222.

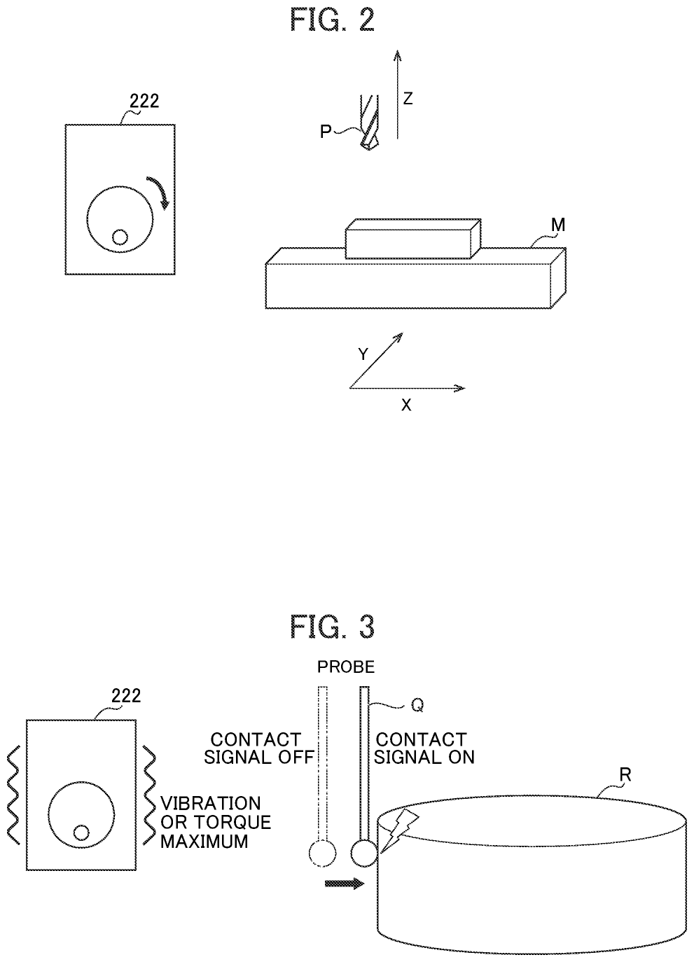

FIG. 2 is a view showing an example of the state of the numerical control device 1. In the example shown in FIG. 2, the numerical control device 1 causes a tool P of the machine tool 2 or the workpiece M to move according to operation of the manual handle 222.

In the case of the machine tool 2 having a plurality of axes, the state identification section 113 identifies the state of an axis to be used among the plurality of axis as the operating state of the numerical control device 1. Then, the selection section 114 selects the type of haptic feedback associated with the state of the axis to be used.

For example, in the case of the weights of the mechanism and/or jig, tool and workpiece related to the axis to be used being heavy, or case of the degree of risk allowance of the axis to be used being high, the type of haptic feedback associated with the state of the axis to be used may be torque or resistance tactile sense generated in the manual handle 222. Then, in the case of the weights of the mechanism, jig, tool and workpiece related to the axis to be used being heavy, or case of the degree of risk allowance of the axis to be used being high, the haptic control section 117 may cause haptic feedback of large torque or large resistance tactile sense to be generated.

In addition, in the case of axis movement not being possible such as emergency stop or a state before the servo system is ready, the type of haptic feedback associated with the state of the axis to be used may be torque generated in the manual handle 222. Then, the haptic control section 117, in the case of axis movement not being possible such as emergency stop or a state before the servo system is ready, may cause haptic feedback of torque of a magnitude such that it is difficult to rotate the manual handle 222 to be generated.

FIG. 3 is a view showing an example of the state of the numerical control device 1. In the example shown in FIG. 3, the numerical control device 1 receives a signal outputted from a probe Q for measurement.

In order to measure a deviation amount in the installed workpiece position, the machine tool 2 has the probe Q for measurement. In this case, the signal outputted from the probe Q for measurement is inputted to the numerical control device 1 as an external signal. Then, the state identification section 113 identifies the state of the numerical control device 1 based on the external signal inputted to the numerical control device 1.

For example, the state identification section 113, in the case of a contact signal (external signal) indicating that the probe Q contacted an object such as the workpiece R being inputted to the numerical control device 1, identifies contact of the probe Q based on the inputted contact signal as the state of the numerical control device 1.

The selection section 114 selects the type of the haptic feedback associated with contact of the probe Q. For example, the type of haptic feedback associated with contact of the probe Q may be a vibration tactile sense or resistance tactile sense generated in the manual handle 222. Then, in the case of a contact signal (external signal) being inputted to the numerical control device 1, the haptic control section 117 may cause haptic feedback such that maximizes a large vibration tactile sense generated in the manual handle 222 or resistance tactile sense in the moving direction of the manual handle 222.

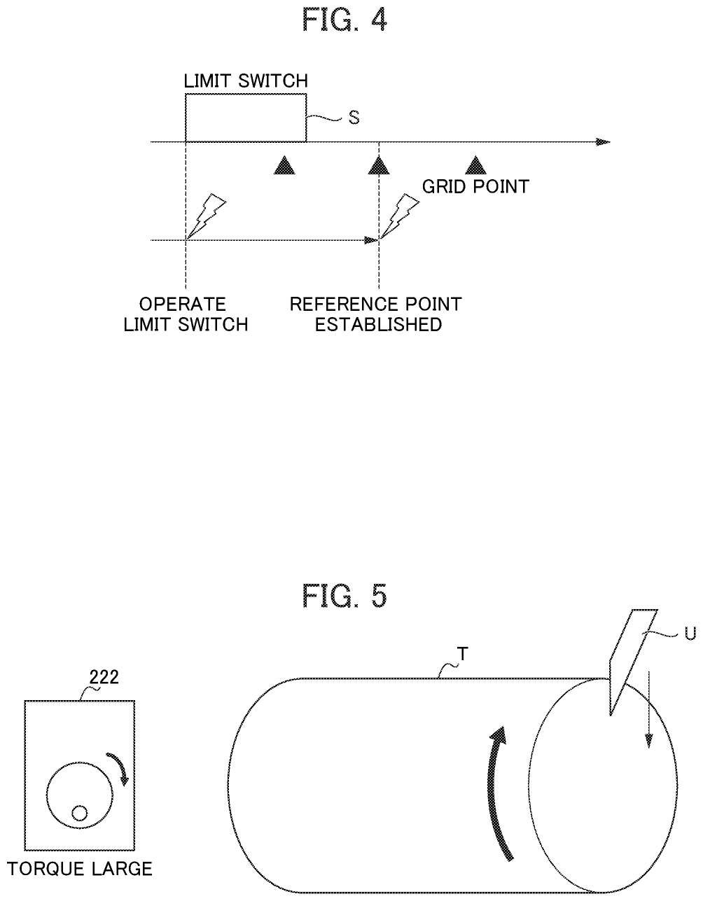

FIG. 4 is a view showing an example of the state of the numerical control device 1. In the example shown in FIG. 4, the numerical control device 1 receives a signal outputted when operating a grid point or limit switch S.

The machine tool 2 has a grid point indicating that the axis has returned to a reference position, or a limit switch S indicating that the axis is at the movement threshold. The signal outputted when operating the grid point or limit switch S is inputted to the numerical control device 1 as an external signal. Then, the state identification section 113 identifies the state of the numerical control device 1 based on the external signal inputted to the numerical control device 1.

The selection section 114 selects the type of haptic feedback associated with operation of the grid point or limit switch S. For example, the type of haptic feedback associated with operation of the grid point or limit switch may be a vibration tactile sense or resistance tactile sense generated in the manual handle 222. Then, the haptic control section 117 may cause haptic feedback maximizing a large vibration tactile sense or resistance tactile sense in the moving direction of the handle, when operating the grid point or limit switch S.

FIG. 5 is a view showing an example of the state of the machine tool 2. In the example shown in FIG. 5, the machine tool 2 is turning processing the workpiece T using a cutting tool U. In the turning processing of such a machine tool 2, the machining load can generally be estimated by calculation from the machining conditions such as the spindle rotation number.

The state identification section 113 identifies the estimated machining load as the state of the machine tool 2. The selection section 114 selects the type of haptic feedback associated with the machining load. For example, the type of haptic feedback associated with the machining load may be the torque or resistance tactile sense generated in the manual handle 222. Then, the haptic control section 117 may cause haptic feedback to be generated so that the resistance tactile sense or torque of the manual handle 222 increases according to the magnitude of the machining load.

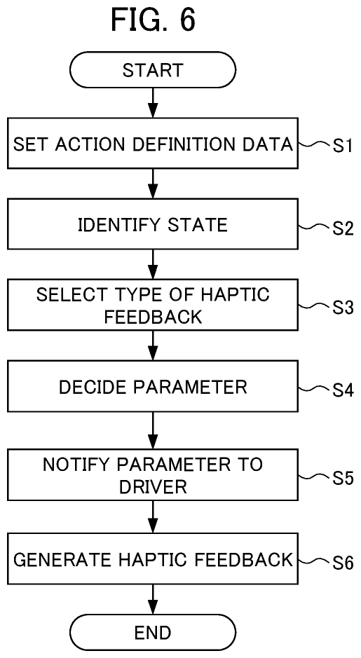

FIG. 6 is a flowchart showing the flow of processing of the numerical control device 1. In Step S1, the action defining section 112 sets the action definition data defining the haptic feedback generated in the manual handle 222. In Step S2, the state identification section 113 identifies the state of the numerical control device 1 or machine tool 2.

In Step S3, the selection section 114 selects the type of haptic feedback based on the action definition data and state of the numerical control device 1 or machine tool 2. In Step S4, the parameter deciding section 115 decides parameters related to haptic feedback based on the type of haptic feedback selected by the selection section 114.

In Step S5, the haptic control section 116 generates a control signal using the parameters decided by the parameter deciding section 115, and notifies the control signal to the driver 2222.

In Step S6, the driver 2222 receives the control signal from the haptic control section 116 of the control unit 11, and outputs the drive signal for generating haptic feedback to the actuator 2223. Then, the actuator 2223 is driven by the drive signal from the driver 2222, and generates haptic feedback.

As explained above, according to the present embodiment, the numerical control device 1 for controlling the machine tool 2 having the manual handle 222 includes: the state identification section 113 which identifies the state of the numerical control device 1 or machine tool 2; and the haptic control section 116 which causes the haptic feedback to be generated in the manual handle 222, based on the state of the numerical control device 1 or machine tool 2 identified by the state identification section 113. In this way, the numerical control device 1 can allow the operator to intuitively feel the state of the machine tool or numerical control device by causing haptic feedback to be generated in the manual handle 222 based on the state of the numerical control device 1 or machine tool 2, and thus can improve the work efficiency.

In addition, the state identification section 113 identifies the state of the numerical control device 1 based on the operating state of the numerical control device 1. The numerical control device 1 can thereby allow the operator to intuitively feel the operating state of the numerical control device 1, and thus can improve the work efficiency.

In addition, the state identification section 113 identifies the state of the numerical control device 1 based on the external signal inputted to the numerical control device 1. The numerical control device 1 can thereby allow the operator to intuitively feel the external signal inputted to the numerical control device 1, and thus can improve the work efficiency.

In addition, the state identification section 113 identifies the state of the machine tool 2 based on the state of the numerical control device 1 and the machine information registered in the numerical control device 1. The numerical control device 1 can thereby allow the operator to intuitively feel the state of the numerical control device 1, and thus can improve the work efficiency.

In addition, the numerical control device 1 further includes: the action defining section 112 which sets action definition data that defines haptic feedback to be outputted to the manual handle 222; the selection section 114 which selects the type of haptic feedback based on the action definition data and state of the numerical control device 1 or machine tool 2; and the parameter deciding section 115 which decides parameters related to haptic feedback based on the type of haptic feedback, in which the haptic control section 116 causes haptic feedback to be generated in the manual handle 222 using the parameters. The numerical control device 1 can thereby cause haptic feedback to be appropriately generated in the manual handle 222.

Although an embodiment of the present invention has been explained above, the present invention is not to be limited to the aforementioned embodiment. In addition, the effects described in the present embodiment are merely listing the most preferred effects produced from the present invention, and the effects from the present invention are not to be limited to those described in the present embodiment.

### EXPLANATION OF REFERENCE NUMERALS

1 numerical control device
2 machine tool
11 control unit
12 storage unit
13 servo amplifier
14 PLC
22 machine control panel
111 manual handle control section
112 action defining section
113 state identification section
114 selection section
115 parameter deciding section
116 haptic control section
221 buttons and switches
222 manual handle
2221 pulse generator
2222 driver
2223 actuator
2224 handle part

1. A numerical control device for controlling a machine tool having a manual handle, the numerical control device comprising:
a state identification section which identifies a state of the numerical control device or the machine tool; and
a haptic control section which causes haptic feedback to be generated in the manual handle based on the state of the numerical control device or the machine tool identified by the state identification section.

2. The numerical control device according to claim 1, wherein the state identification section identifies the state of the numerical control device based on an operating state of the numerical control device.

3. The numerical control device according to claim 1, wherein the state identification section identifies the state of the numerical control device based on an external signal inputted to the numerical control device.

4. The numerical control device according to claim 1, wherein the state identification section identifies the state of the machine tool based on the state of the numerical control device and machine information registered in the numerical control device.

5. The numerical control device according to claim 1, wherein the numerical control device further comprises:
an action defining section which sets action definition data that defines the haptic feedback to be outputted to the manual handle;
a selection section which selects a type of the haptic feedback based on the action definition data and the state of the numerical control device or the machine tool; and
a parameter deciding section that decides a parameter related to the haptic feedback based on the type of the haptic feedback,
wherein the haptic control section causes the haptic feedback to be generated in the manual handle using the parameter.
